(19) United States
(12) Patent Application Publication
(10) Pub. No.: US 2018/0054077 A1
(43) Pub. Date: Feb. 22, 2018

(54) SHIELD FOR A WIRELESSLY CHARGED ELECTRONIC DEVICE

(71) Applicant: APPLE INC., Cupertino, CA (US)

(72) Inventors: Makiko K. Brzezinski, San Jose, CA (US); Maegan K. Spencer, Emerald, CA (US); Christopher S. Graham, San Francisco, CA (US); Katherine E. Tong, San Francisco, CA (US)

(73) Assignee: APPLE INC., Cupertino, CA (US)

(21) Appl. No.: 15/239,750

(22) Filed: Aug. 17, 2016

(51) Int. Cl. H02J 7/02; H02J 50/90

(52) U.S. Cl. CPC H02J 7/025; H02J 50/90; H02J 7/027

(57) ABSTRACT

An inductively charged portable electronic device has a charging receive coil that receives electromagnetic energy during a charge event. An electrically conductive shield is disposed within the portable electronic device and is disposed between the charging receive coil and an exterior housing of the portable electronic device to shield a touch sensitive user interface of the portable electronic device from noise generated during a charge event.

### FIELD

The described embodiments relate generally to a wirelessly charged electronic device that includes a touch sensitive user interface screen. More particularly, the present invention relates to a wirelessly charged electronic device that includes an electrically conductive shield to shield the touch sensitive user interface from electromagnetic interference generated during inductive charging of the electronic device.

### BACKGROUND

Mobile devices such as smart phones, tablets, smart watches, and the like can be configured for wireless charging. Such mobile devices are often sold along with a wireless charging device (e.g., a charging station) that is specifically configured for charging the mobile device. During wireless charging users may wish to communicate with the mobile device by interacting with its touch sensitive user interface.

### SUMMARY

Some embodiments of the present disclosure relate to portable electronic devices that are inductively charged and have one or more electrically conductive shields configured to attenuate electromagnetic noise generated during a charging event. Some embodiments relate to electrically conductive shields that are specifically configured to attenuate electromagnetic noise that interferes with a touch sensitive user interface on the portable electronic device.

In some embodiments an electronic device comprises an housing having a charging surface through which electromagnetic energy can be transferred and an inductive charging receive coil disposed within the electronic device adjacent to the charging surface and configured to receive electromagnetic energy through the charging surface. An electrically conductive shield is disposed between the inductive charging receive coil and the charging surface and is electrically coupled to a ground potential of the electronic device.

In some embodiments the electrically conductive shield is located on an interior surface of the housing. In various embodiments the electrically conductive shield has a sheet resistance between 2 ohm/square and 15 kiloohm/square. In some embodiments the electrically conductive shield comprises a layer of electrically conductive carbon. In various embodiments the layer of electrically conductive carbon has a sheet resistance between 2 ohm/square and 15 kiloohm/square and is between 5 to 50 microns thick.

In some embodiments the housing comprises glass. In various embodiments the electronic device further comprises a touch sensitive user interface and the electrically conductive shield is positioned and configured to shield the touch sensitive user interface from electromagnetic interference generated during inductive charging of the electronic device. In various embodiments one or more alignment features enable the charging surface to be properly aligned with a wireless charger for a charging event. In some embodiments the one or more alignment features include one or more magnets that assist in aligning the charging surface to the wireless charger.

In some embodiments an inductively charged electronic device comprises a housing having a charging surface through which electromagnetic energy can be transferred, the charging surface positioned on a first exterior surface of the housing. A cover glass is coupled to the housing and defines a second exterior surface of the housing opposite the first exterior surface. A display is positioned within the housing adjacent to and visible through the cover glass. An inductive charging receive coil positioned within the housing and is configured to receive electromagnetic charging energy through the charging surface and an electrically conductive shield is positioned between the charging surface and the inductive charging receive coil, the electrically conductive shield coupled to a ground potential of the electronic device and configured to attenuate electromagnetic noise generated during inductive charging of the electronic device.

In some embodiments the electrically conductive shield is disposed on an interior surface of the housing. In various embodiments the cover glass and the display are a portion of a touch sensitive user interface. In some embodiments the housing comprises the cover glass, a metal frame and a back crystal, wherein the electrically conductive shield is formed on a portion of the back crystal. In various embodiments the electrically conductive shield comprises a layer of electrically conductive carbon.

In some embodiments the layer of electrically conductive carbon has a sheet resistance between 2 ohm/square and 15 kiloohm/square and is between 5 to 50 microns thick. In various embodiments a conductor is electrically coupled to the electrically conductive shield with an electrically conductive epoxy and couples the electrically conductive shield to the ground potential. In some embodiments at least a portion of the housing is made from a glass material.

In some embodiments an electronic system comprises an inductively charged electronic device including a touch sensitive user interface, an housing through which electromagnetic energy can be transferred, and an inductive charging receive coil disposed within the electronic device and configured to receive electromagnetic energy through the housing. An inductive charging station has an inductive charging transmit coil configured to transmit electromagnetic energy to the inductive charging receive coil of the electronic device, and an electrically conductive shield is disposed between the inductive charging receive coil and the inductive charging transmit coil and configured to shield the touch sensitive user interface from electromagnetic interference generated during inductive charging of the electronic device.

In some embodiments the electrically conductive shield is disposed on the electronic device. In various embodiments the electrically conductive shield is disposed on the inductive charging station.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a front perspective view of an inductively charged electronic device on a charging station according to an embodiment of the disclosure;

FIG. 2 is a cross-sectional view of the electronic device and the charging station shown in FIG. 1;

FIG. 3 is a close-up view of a portion of the cross-section shown in FIG. 2;

FIGS. 4A and 4B are perspective views of an inductively charged watch according to an embodiment of the disclosure;

FIG. 4C is a perspective view of the inductively charged watch illustrated in FIGS. 4A and 4B disposed on a charging station;

FIG. 5 is an exploded view of a back crystal with an electrically conductive shield on an inner surface and an inductive charging receive coil of the watch illustrated in FIGS. 4A-4C;

FIG. 6 is a perspective view of a back crystal of the watch illustrated in FIGS. 4A-4C with an electrically conductive shield on an inner surface;

FIG. 7 is a perspective view of a back crystal of the watch illustrated in FIGS. 4A-4C with an electrically conductive shield on an inner surface;

FIGS. 8-11 are cross-sections showing methods of coupling a conductor to an electrically conductive shield according to embodiments of the disclosure; and

FIG. 12 is a system schematic of an inductively charged electronic device and a docking station according to an embodiment of the disclosure.

### DETAILED DESCRIPTION

Some embodiments of the present disclosure relate to an inductively (i.e., wirelessly) charged electronic device that has a touch sensitive display for interaction with a user. During a charge event a user may wish to communicate with the electronic device using the touch sensitive display. An electrically conductive shield is positioned within the electronic device to attenuate electromagnetic noise generated during inductive charging of the electronic device so the electromagnetic noise does not interfere with the performance of the touch sensitive display.

While the present disclosure can be useful for a wide variety of configurations, some embodiments of the disclosure are particularly useful for relatively compact electronic devices that have inductive charging coils located relatively close to a touch sensitive display, as described in more detail below.

For example, in some embodiments a portable electronic device is placed on a charging station for a charging event. An inductive charging receive coil within the portable electronic device receives electromagnetic charging energy from the charging station through a charging surface. An electrically conductive shield is coupled to a ground of the portable electronic device and is disposed between the inductive charging coil and the charging surface. The electrically conductive shield is configured to attenuate electromagnetic noise generated during a charging event so it does not interfere with a user's operation of the touch sensitive display on the portable electronic device.

In another example the electrically conductive shield is formed from an electrically conductive layer of carbon particles adhered to a rear housing of the electronic device. One or more conductors are coupled to the electrically conductive shield with an electrically conductive epoxy and couple the electrically conductive shield to ground of the portable electronic device. In a further example, the rear housing and charging surface of the portable electronic device is a back crystal of a watch and is made of a glass material.

In order to better appreciate the features and aspects of electrically conductive shields for electronic devices according to the present disclosure, further context for the disclosure is provided in the following section by discussing one particular implementation of an electronic device according to embodiments of the present disclosure. These embodiments are for example only and other embodiments can be employed in other electronic devices such as, but not limited to computers, media players and other electronic devices.

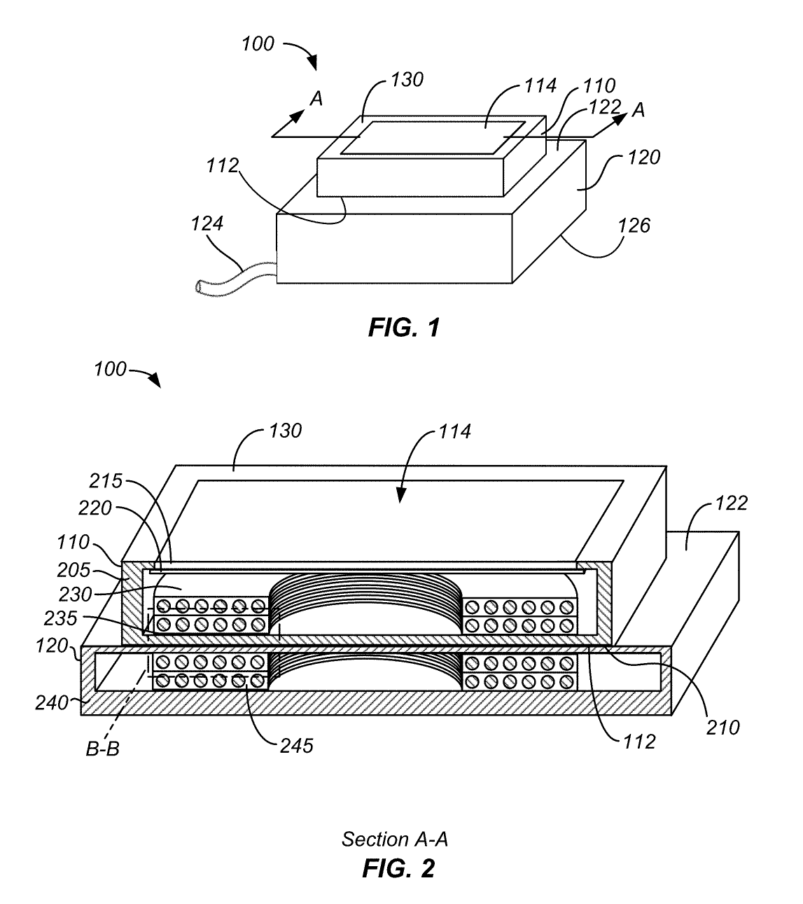

FIG. 1 is a front isometric view illustrating a system 100 that enables a portable electronic device to be wirelessly charged. System 100 may include a portable electronic device 110, such as a wearable electronic device, and a wireless charger 120, such as a docking station. Although FIG. 1 illustrates portable electronic device 110 and wireless charger 120 as specific devices having particular shapes and sizes relative to each other, the illustrated devices merely serve as an example. In various implementations, either portable electronic device 110 or wireless charger 120 may be a variety of different types of electronic devices having a variety of different shapes and/or sizes provided that wireless charger 120 is configured to wirelessly charge a battery or other power source within portable electronic device 110. For example, portable electronic device 110 may be a tablet computer, a mobile computing device, a smart phone, a cellular telephone, a digital media player, or a variety of different types of wearable electronic devices. One example of a wearable device that portable electronic device 120 may represent can be worn on a user's wrist like a watch and includes a display to indicate the date and time, but can also do much more than act as a simple time piece. For example, the device may include may also include accelerometers and one or more sensors that enable a user to track fitness activities and health-related characteristics, such as heart rate, blood pressure, and body temperature, among other information. Similarly, wireless charger 120 may be a stand-alone dock or may be incorporated into another electronic device, such as a stereo receiver, a clock radio, or other device.

As illustrated in FIG. 1, portable electronic device 110 includes a charging surface 112 that is operable to contact a charging face 122 of wireless charger 120. In some embodiments, charging surface 112 and charging face 122 form a sliding interface between portable electronic device 110 and wireless charger 120. As such, the two devices may be positionable with respect to each other in one or more directions.

Wireless charger 120 includes a power transmitting component (not shown) that is positioned adjacent to charging face 122 of housing 126. The power transmitting component can wirelessly transmit power across charging face 122 to portable electronic device 110 to charge one or more batteries or other power sources within the portable electronic device. In some embodiments charging face 122 can have a concave shape that matches a convex shape of charging surface 112 of portable electronic device 110. In order to provide power to the power transmitting component, wireless charger 120 can receive power from an external source through a cable 124 or other connection or can include its own power source, such as a battery (not shown).

Portable electronic device 110 has a touch sensitive user interface 114 or other medium through which information, such as the date and time, phone calls, text messages, emails and other alerts may be displayed and can be disposed on a second exterior surface 130. In various embodiments an inductive charging receive coil (not shown) is positioned within portable electronic device 110 and configured to receive electromagnetic charging energy through charging surface 112. An electrically conductive shield (not shown) can be positioned between charging surface 112 and the inductive charging receive coil to attenuate electromagnetic noise generated during inductive charging of the electronic device, as described in more detail below. In some embodiments the reduced electromagnetic noise may make touch sensitive user interface 114 easier for a user to interact with.

Now referring to FIG. 2, a cross-section A-A through a portion of portable electronic device 110 and wireless charger 120 illustrated in FIG. 1 is shown. A housing 205 of portable electronic device 110 has a first exterior surface 210 that includes charging surface 112 shown in FIG. 2 as positioned adjacent to and abutting a charging face 122 of wireless charger 120. In some embodiments at least a portion of housing 205 may be made from zirconia, a glass material and/or a plastic. Second exterior surface 130 of housing 205 may be defined by a touch sensitive user interface 114 that can include a cover glass 215 and a display 220. Display 220 may be positioned within housing 205, adjacent to and visible through cover glass 215. In some embodiments a metallic or plastic frame portion of housing 205 can be used to hold cover glass 215 portion of the housing in place.

An inductive charging receive coil 230 is positioned within housing 205 of portable electronic device 110 and is configured to receive electromagnetic charging energy through charging surface 112. An electrically conductive shield 235 is positioned between charging surface 112 and inductive charging receive coil 230. Electrically conductive shield 235 may be coupled to a ground potential of portable electronic device 110 and configured to attenuate electromagnetic noise generated during inductive charging of the portable electronic device so it does not interfere with the operation of touch sensitive display 114.

Wireless charger 120 has a charger housing 240 with a charging face 122 designed to receive portable electronic device 110. Wireless charger 120 may have an inductive charging transmit coil 245 configured to transmit electromagnetic energy to inductive charging receive coil 230 of portable electronic device 110. In some embodiments wireless charger 120 may have one or more alignment features (e.g., magnets) that enable charging surface 112 of portable electronic device 110 to be properly aligned with charging face 122 of the wireless charger for a charging event.

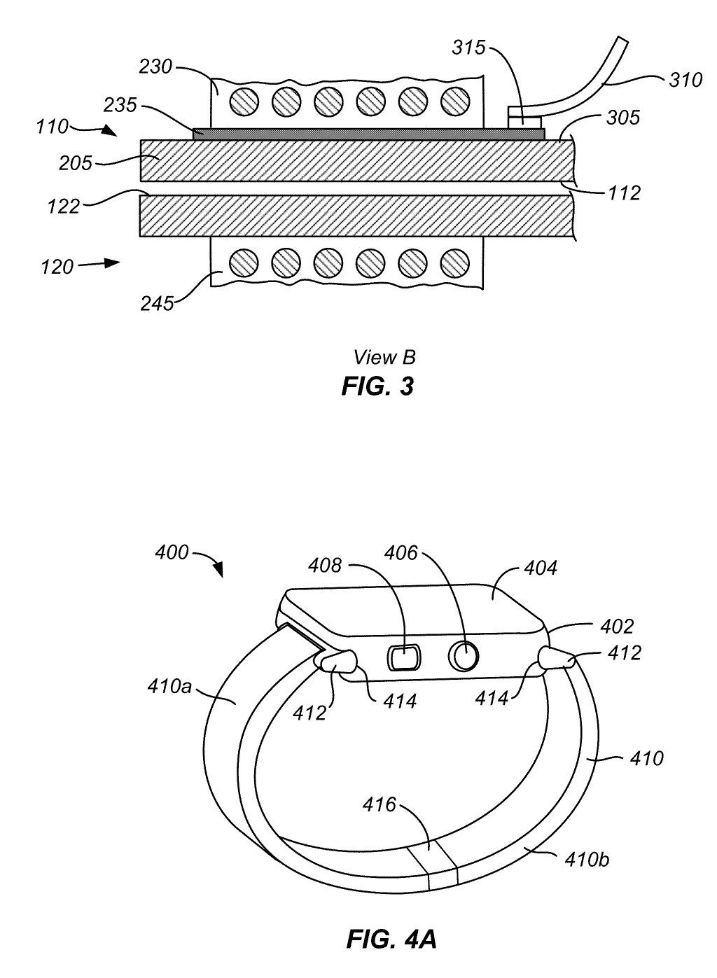

Now referring to FIG. 3 a close up view of area B-B, representing a portion of portable electronic device 110 and wireless charger 120 illustrated in FIG. 1, is shown. As shown in FIG. 3, electrically conductive shield 235 is positioned between receive coil 230 and an interior surface 305 of housing 205. In some embodiments electrically conductive shield 235 may be a concentric ring disposed only under receive coil 230, as shown, however in other embodiments it may have a different shape such as a filled circle or any other two-dimensional shape, as described in more detail below. In some embodiments a conductor 310 can be electrically coupled to electrically conductive shield 235 with an electrically conductive epoxy 315, however some embodiments may use a different interconnect. Conductor 310 can be coupled to a ground of portable electronic device 110 so electrically conductive shield 235 attenuates electromagnetic energy generated during a charging event to minimize interference with touch sensitive user interface 114 (see FIG. 2).

In some embodiments, during a charge event, electrically conductive shield 235 may be designed as a “selective shield” allowing electromagnetic charging energy to be transferred from transmit coil 245 to receive coil 230 while simultaneously attenuating electromagnetic noise that interferes with the operation of touch sensitive user interface 114 (see FIG. 2). For example, in some embodiments touch sensitive user interface 114 may reference a system ground that may be unstable due to electromagnetic noise generated by a charge event. The noise may result in a lack of detection, false detection, inaccuracy in detected position, a jittery display or other unfavorable conditions of touch sensitive user interface 114. Conductive shield 235 may be configured to reduce the noise on the system ground, improving the function of the touch sensitive user interface 114 while allowing charge energy to be passed to receive coil 230.

In some embodiments it may be desirable to optimize the selective transmittance and shielding properties of electrically conductive shield 235 by tuning the electrical conductivity, the thickness, the geometry and/or the material of the electrically conductive shield as described in more detail below. In one example the sheet resistivity of electrically conductive shield 235 may be reduced to improve its shielding performance while the electrically conductive shield may also be patterned or reduced in thickness to minimize eddy currents that can cause a reduction in inductive charge efficiency.

In one embodiment, electrically conductive shield 235 is formed by a layer of conductive carbon that is adhered to an interior surface 305 of housing 205. In some embodiments the layer of conductive carbon can first be deposited as an ink that is later cured. In some embodiments the layer of conductive carbon has a sheet resistance of 2 kiloohms/square and is between 8-12 microns thick, however it may have other properties and thicknesses as described in more detail below. Some embodiments may use a different material for electrically conductive shield 235, as also discussed in more detail below.

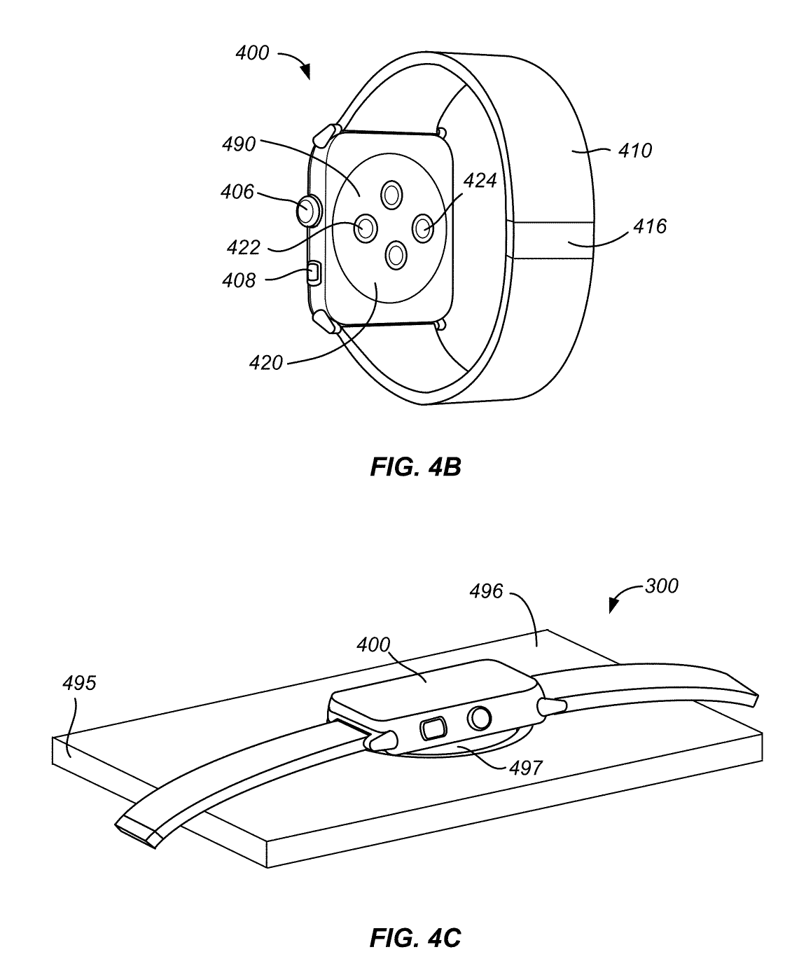

Reference is now made to FIGS. 4A and 4B, that depict front and rear perspective views of one type of portable electronic device with which embodiments of the electrically conductive shield 235 (see FIG. 3) may be used. As shown, wearable electronic device 400 includes a casing 402 that houses a display 404 and various input devices including a dial 406 and a button 408.

Device 400 may be worn on a user's wrist and secured thereto by a band 410. Band 410 includes lugs 412 at opposing ends of the band that fit within respective recesses or apertures 414 of the casing and allow band 410 to be removably attached to casing 402. Lugs 412 may be part of band 410 or may be separable (and/or separate) from the band. Generally, the lugs may lock into recesses 414 and thereby maintain connection between the band and casing 402. The user may release a locking mechanism (not shown) to permit the lugs to slide or otherwise move out of the recesses. In some wearable devices, the recesses may be formed in the band and the lugs may be affixed or incorporated into the casing.

Casing 402 which may also be referred to as a housing, also houses electronic circuitry (not shown in FIGS. 4A or 4B) , including a processor and communication circuitry, along with sensors 422, 424 that are exposed on a bottom surface 420 of casing 402. In some embodiments casing 402 may be made from a metal or plastic and can include a back crystal 490 that may be made from a glass or other material, and a glass display 404 . The circuitry, sensors, display and input devices enable wearable electronic device 400 to perform a variety of functions including, but not limited to: keeping time; monitoring a user's physiological signals and providing health-related information based on those signals; communicating (in a wired or wireless fashion) with other electronic devices; providing alerts to a user, which may include audio, haptic, visual and/or other sensory output, any or all of which may be synchronized with one another; visually depicting data on a display; gathering data form one or more sensors that may be used to initiate, control, or modify operations of the device; determining a location of a touch on a surface of the device and/or an amount of force exerted on the device, and use either or both as input; accepting voice input to control one or more functions; accepting tactile input to control one or more functions; and so on.

A battery (not shown in FIGS. 4A or 4B) internal to casing 402 powers wearable electronic device 400. The battery can be inductively charged by an external power source, such as wireless charger, and wearable electronic device 400 can include circuitry configured to operate as a receiver in a wireless power transfer system as described with respect to FIGS. 1 and 2. Bottom surface 420 of electronic device 400 can have a convex shape that enables the surface to facilitate proper alignment to a wireless power transmitter in the wireless charger. Also, while not shown in FIGS. 4A or 4B, portable electronic device 400 may include one or more magnets or magnetic plates that can further assist in aligning device 400 to the charging surface of a wireless charger.

FIG. 4C is a perspective view of a wireless charger 495 with wrist-worn portable electronic device 400 shown in FIGS. 4A and 4B placed on the charger in a charging position. As shown in FIG. 4C, wrist-worn portable electronic device 400 lies essentially flat across upper surface 496 of charger 495 in the charging position. Bottom surface 420 of device 400 can align with an optional concave charging surface 497 of wireless charger 495 to facilitate proper alignment of the wireless power receiving components within device 400 with the wireless power transmitting components within charger 495. Additionally, one or more alignment magnets (not shown) can also facilitate proper alignment between the wireless power receiving and transmitting components.

A power transmitting coil (not shown) is positioned under charging surface 497 and an alignment magnet (not shown) may be centered within the charging surface. When a portable electronic device is positioned against charging surface 497, the alignment magnet, which can be in a fixed position within charger 495, can help center electronic device 400 to the power transmitting coil thus increasing the efficiency of any charging operation.

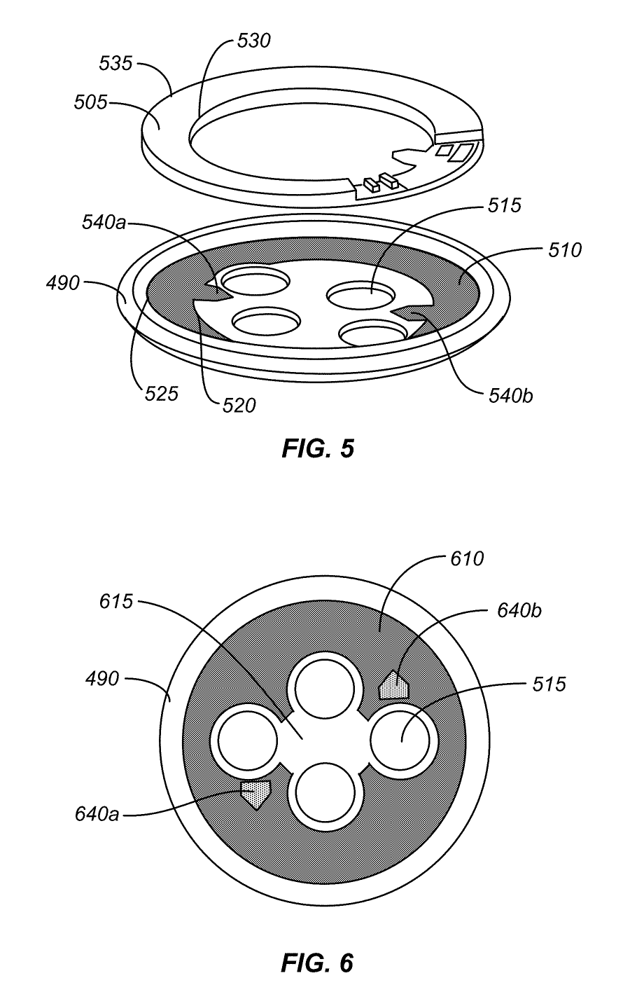

Now referring to FIG. 5 an exploded top perspective view of back crystal 490 of wearable electronic device 400 and inductive charging receive coil 505 is illustrated. In some embodiments electrically conductive shield 510 is disposed adjacent to and/or adhered to back crystal 490. Back crystal 490 may have one or more apertures 515 through its thickness that can be used to transmit and receive optical information that can be used for functions, such as, for example a monitoring a user's physiological signals.

In some embodiments electrically conductive shield 510 may be formed on back crystal 490 using an electrically conductive ink, as discussed above. In various embodiments the conductive ink may be silkscreened, pad printed, sprayed or otherwise deposited on back crystal 490 and cured, leaving a layer of electrically conductive carbon.

In further embodiments electrically conductive shield 510 may be formed with one or more layers of metal. The following are only examples of metal layers, other combinations, thicknesses and types of metal layers can be used for conductive shield 510 and are within the scope of this disclosure. Some non-limiting example combinations of metal layers are: a first layer of titanium approximately 100 nanometers thick followed by a layer of aluminum approximately 100 nanometers thick followed by an optional added layer of aluminum/titanium nitride that is thick, a single layer of titanium approximately 100 nanometers thick followed by an optional approximately 200 nanometers layer of aluminum/titanium nitride that is approximately 200 nanometers thick, a single layer of titanium approximately 100 nanometers thick or a single layer of tantalum that is approximately 100 nanometers thick. In some embodiments the one or more layers of metal can be sputtered, plated or otherwise deposited on back crystal 490.

In further embodiments electrically conductive shield 510 can be made from an electrically conductive paste combined with a glass frit that is formulated to be fired onto back crystal 490. The paste may contain silver, gold or any other conductive particles and may be printed or dispensed on back crystal 490, then fired in place using a furnace. In further embodiments electrically conductive shield 510 may be an electrically conductive label that is adhered to back crystal 490.

In some embodiments electrically conductive shield 510 can be made from a flexible printed circuit material such as, for example a layer of metal sandwiched between layers of an organic material such as polyamide also called a “flex circuit”.

In some embodiments where back crystal 490, is made from a plastic material, electrically conductive shield 510 may be an electrically conductive label that is co-molded with a portion of the back crystal. In further embodiments, laser direct structuring (LDS) along with an associated plating process can be used to define and form electrically conductive shield 510 on back crystal 490.

As discussed above the selective transmittance and shielding properties of electrically conductive shield 510 can be achieved by optimizing the electrical conductivity, the thickness, the geometry and/or the material of the electrically conductive shield. Generally speaking, in some embodiments the material of electrically conductive shield 510 may have a relatively high sheet resistance and be relatively thick and/or have broad coverage on back crystal 490. In other embodiments the material of electrically conductive shield 510 may have a relatively low sheet resistance and be relatively thin and/or have reduced coverage on back crystal 490. Those of skill in the art will recognize that myriad variations of material properties and geometries of electrically conductive shield 510 can function as a shield as described herein and are within the scope of this disclosure.

In some embodiments electrically conductive shield 510 is designed to have a relatively high sheet resistance of 2 kiloohms/square and is between 8-12 microns thick. In further embodiments the 8-12 micron thick electrically conductive shield may have a sheet resistance between 1 kiloohm/square and 3 kiloohms/square while in various embodiments it may be between 0.5 kiloohms/square and 4 kiloohms/square. In some embodiments the 8-12 micron thick electrically conductive shield 510 may have a sheet resistance between 2 ohms/square and 15 kiloohms/square.

In some embodiments electrically conductive shield 510 is designed to have a relatively low sheet resistance of less than 2 ohms/square and may have a thickness between 0.1 to 5 microns, and/or is patterned. In one embodiment electrically conductive shield 510 has a sheet resistance of 0.6 ohms/square, is 1 micron thick and covers a significant portion of back crystal 490.

These are merely examples and as discussed above, depending on the particular geometry of electrically conductive shield 510, other sheet resistance values and thicknesses may be used to achieve the appropriate shielding and transmittance performance.

In some embodiments back crystal 490 may be zirconia, ceramic, a glass or a plastic material. In further embodiments, any material that allows electromagnetic charging energy to pass through it can be used for back crystal 490.

Now referring to FIGS. 5-7, a few example geometries of electrically conductive shields are illustrated, however these are for example only and other patterns/geometries of electrically conductive shields are within the scope of this disclosure. For example, in FIG. 5 electrically conductive shield 510 is in the pattern of a ring having an inner ring diameter 520 and an outer ring diameter 525 that are concentric and similar in size to inner diameter 530 and outer diameter 535 of transmit coil 505 In some embodiments electrically conductive shield 510 may have one or more ground contact areas 540a, 540b used for securing one or more conductors 310 (see FIG. 3) that are coupled to a ground of the portable electronic device.

Now referring to FIG. 6, in comparison to the embodiment illustrated in FIG. 5, electrically conductive shield 610 covers an entire inner surface of back crystal 490, except for apertures 515 and middle portion 615 disposed between the apertures. Electrically conductive shield 610 may also have one or more ground contact areas 640a, 640b used for securing one or more conductors 310 (see FIG. 3) that are coupled to a ground of the portable electronic device.

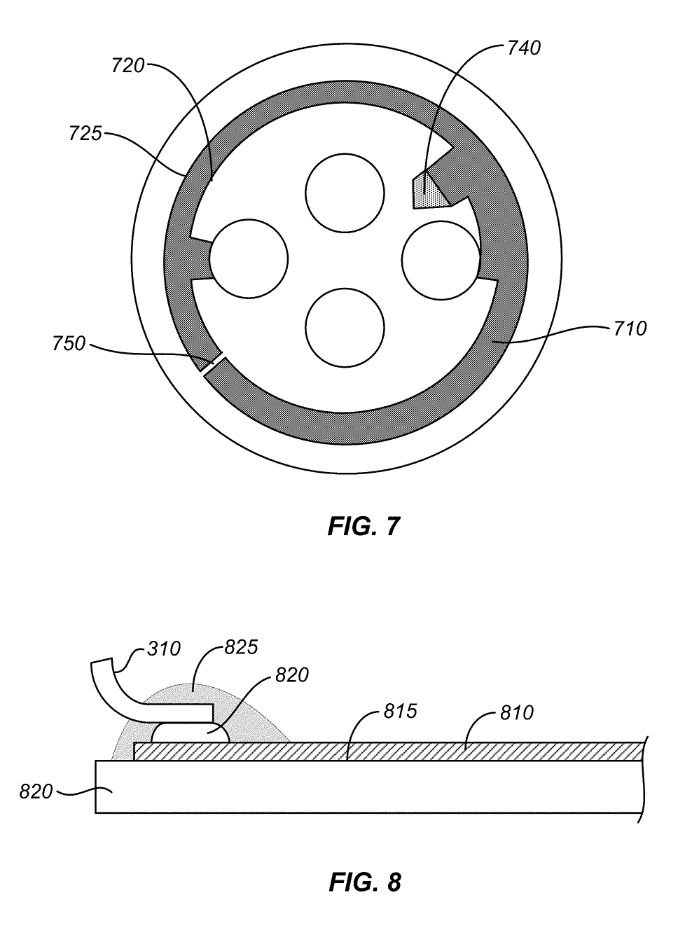

Now referring to FIG. 7, electrically conductive shield 710 is similar to electrically conductive shield 510 illustrated in FIG. 5, resembling a ring having an outer ring diameter that approximately matches an outer diameter of receive coil 505 (see FIG. 5). However, electrically conductive shield 710 has an inner ring diameter 720 that is greater than inner diameter 530 (see FIG. 5) of transmit coil 505. Electrically conductive shield 710 may also have one or more gaps 750. Electrically conductive shield 710 may further have one or more ground contact areas 740 used for securing one or more conductors 310 (see FIG. 3) that are coupled to a ground of the portable electronic device.

Now referring to FIGS. 8-11, examples of coupling an electrical conductor 310 to an electrically conductive shield 810 are illustrated, however other methods may be used and are within the scope of this disclosure. FIG. 8 illustrates an electrically conductive shield 810 disposed on an interior surface 815 of a substrate 820. Substrate 820 can be a housing of an electronic device, a back crystal of an electronic device or a housing of a charger as described herein. In this example, conductor 310 is bonded to electrically conductive shield 810 using an electrically conductive adhesive 820. Conductor 310 may be a wire, a flexible circuit (e.g., a conductive metal disposed on a flexible polymer), a wirebond, a metallic ribbon or any other type of electrical conductor. Conductive adhesive 820 may be any type of adhesive that is filled with silver, gold or any other electrically conductive material. Conductive adhesive 820 can be used to form an electrical connection between electrically conductive shield 810 and conductor 310, while also providing a mechanical support structure between the conductor and the electrically conductive shield. An optional bonding material 825 that can be any type of epoxy or adhesive can be disposed over the interconnect region to provide additional structural integrity for the interconnect.

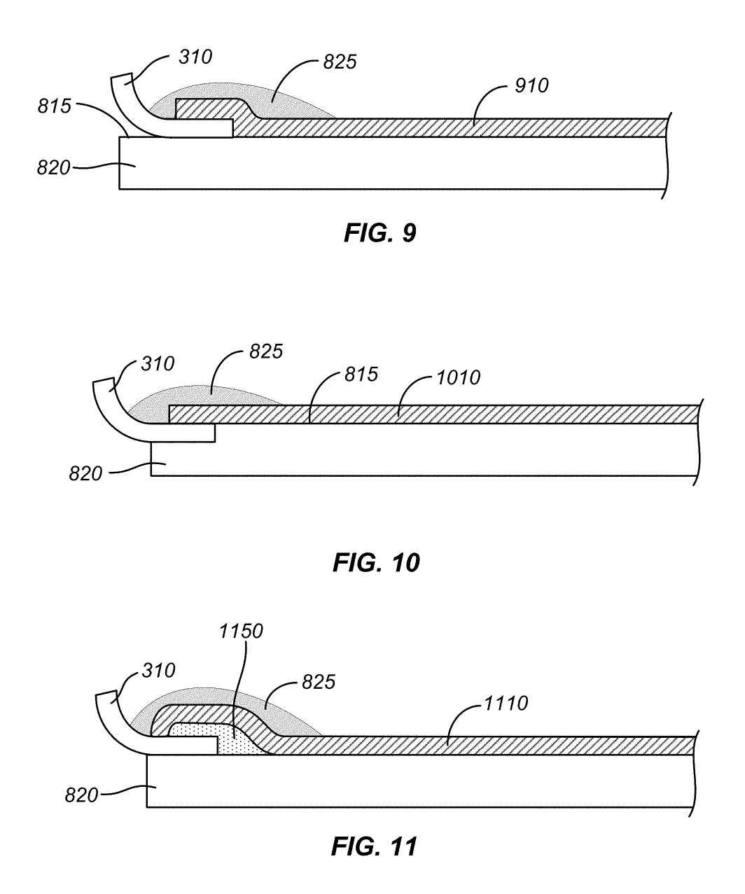

Now referring to FIG. 9, another example embodiment showing a method of coupling an electrical conductor 310 to an electrically conductive shield 910 is illustrated. In this embodiment, conductor 310 is adhered to interior surface 815 of housing 820 and electrically conductive shield 910 is formed over the conductor. For example, in one embodiment conductor 310 may be a metallic ribbon that is adhered to substrate 820 with an epoxy, then electrically conductive shield 910 is deposited on the substrate and ribbon. Electrically conductive shield 910 is in contact with conductor 310 such that the electrically conductive shield can be grounded by conductor 310. An optional bonding material 825 that can be any type of epoxy or adhesive can be disposed over the interconnect region to provide additional structural integrity for the interconnect.

Now referring to FIG. 10, another embodiment showing a method of coupling an electrical conductor 310 to an electrically conductive shield 1010 is illustrated. This embodiment is similar to FIG. 9, however in this embodiment conductor 310 is recessed into top surface 825 of substrate 820 such that electrically conductive shield 1010 is substantially planar while being disposed at least partially over the conductor. In some embodiments conductor 310 may be secured to substrate 820 with an adhesive or other method. This embodiment may be useful for forming connections to substrates made from a plastic material where conductor 310 can be easily recessed, however this embodiment is not limited to plastic substrates. An optional bonding material 825 that can be any type of epoxy or adhesive can be disposed over the interconnect region to provide additional structural integrity for the interconnect.

Now referring to FIG. 11, another embodiment showing a method of coupling an electrical conductor 310 to an electrically conductive shield 1010 is illustrated. This embodiment is similar to the embodiment illustrated in FIG. 9, however in this embodiment an electrically conductive adhesive or other material 1150 is disposed partially over a top surface of conductor and on substrate 820. In some embodiments electrically conductive adhesive or other material 1150 may provide a more gentle transition for conductive shield 1110 and/or a mechanically buffered interface between conductor 310, substrate 820 and electrically conductive shield 1110 to make the connection more reliable and less susceptible to cracks forming in the electrically conductive shield. An optional bonding material 825 that can be any type of epoxy or adhesive can be disposed over the interconnect region to provide additional structural integrity for the interconnect.

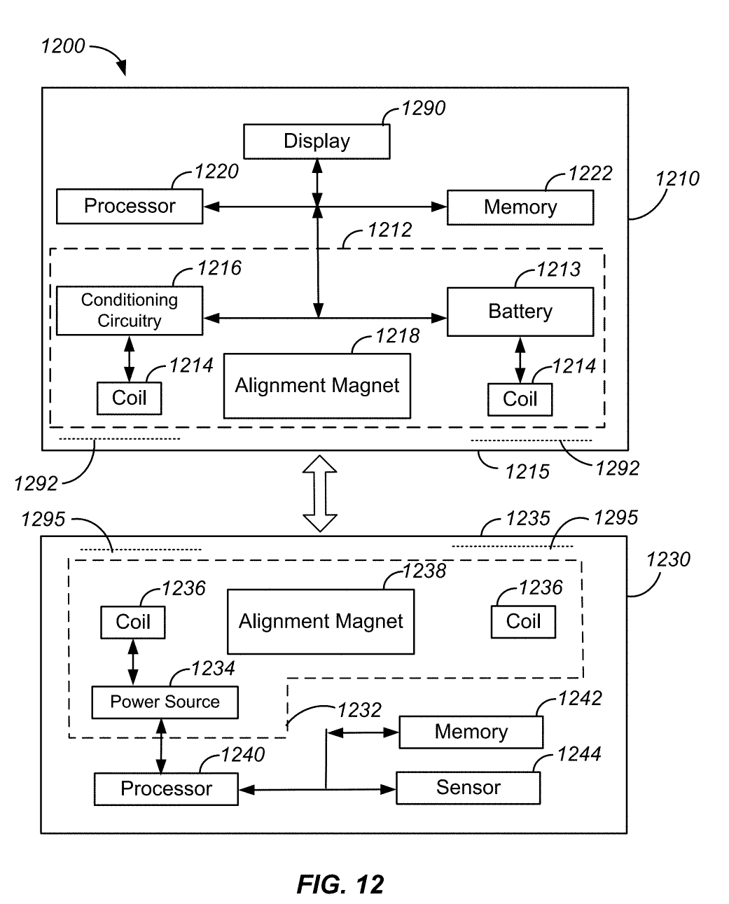

Now referring to FIG. 12, a simplified block diagram of various power-related components in a system 1200 that includes a portable electronic device 1210 and a wireless charger 1230 is illustrated. System 1200 can be representative of system 100 or any other inductively charged system. Portable electronic device 1210 can be, for example, portable electronic device 110 discussed above. Wireless charger 1230 can be, for example, wireless charger 120 discussed above.

As shown in FIG. 12, portable electronic device 1210 includes an inductive power-receiving component 1212 while wireless charger 1230 includes a power-transmitting component 1232. In system 1200, power receiving component 1212 can be operatively coupled to power transmitting component 1232 to charge a battery 1213 within the portable electronic device. Within the power receiving component, battery 1213 is operably connected to a receive coil 1214 via power conditioning circuitry 1216. Receive coil 1214 can be inductively coupled to a transmit coil 1236 of wireless charger 1230 to receive power wirelessly from the charger and pass the received power to battery 1213 within the portable electronic device via power conditioning circuitry 1216.

Power conditioning circuitry 1216 can be configured to convert alternating current received by the receive coil 1214 into direct current power for use by other components of portable electronic device 1210. Also within device 1210, a processing unit 1220 may direct the power, via one or more routing circuits and under the execution of an appropriate program residing in a memory 1222, to perform or coordinate one or more functions of the portable electronic device typically powered by battery 1213.

Within wireless charger 1230, power transmitting component 1232 includes a power source 1234 operatively coupled to transmit coil 1236 to transmit power to portable electronic device 1210 via electromagnetic induction or magnetic resonance. Transmit coil 1236 can be an electromagnetic coil that produces a time-varying electromagnetic flux to induce a current within an electromagnetic coil within the portable electronic device (e.g., coil 1214). The transmit coil may transmit power at a selected frequency or band of frequencies. In one example the transmit frequency is substantially fixed, although this is not required. For example, the transmit frequency may be adjusted to improve power transfer efficiency for particular operational conditions. More particularly, a high transmit frequency may be selected if more power is required by the accessory and a low transmit frequency may be selected if less power is required by the accessory. In other examples, transmit coil 1236 may produce a static electromagnetic field and may physically move, shift, or otherwise change its position to produce a spatially-varying electromagnetic flux to induce a current within the receive coil.

When portable electronic device 1210 is operatively attached to wireless charger 1230 (e.g., by aligning charging surface 1215 of device 1210 with charging face 1235 of wireless charger 1230), the portable electronic device may use the received current to replenish the charge of its rechargeable battery or to provide power to operating components associated with the electronic device. Thus, when portable electronic device 1210 is operatively attached to wireless charger 1230, the charger may wirelessly transmit power at a particular frequency via transmit coil 1236 to receive coil 1214 of the portable electronic device.

While charger is wirelessly transmitting power electromagnetic noise may be generated that interferes with the operation of a touch sensitive display 1290 of portable electronic device 1210. In one embodiment an electrically conductive shield 1292 may be placed between receive coil 1214 and charging surface 1215 and coupled to a ground to attenuate the generated electromagnetic noise. In some embodiments electrically conductive shield 1292 can be formed across an entire inner surface of a housing of portable electronic device 1210 or only disposed under receive coil 1214 or a portion of the receive coil. In further embodiments a charger-based electrically conductive shield 1295 disposed within wireless charger 1230 can be used in addition to, or in place of electrically conductive shield 1292. In further embodiments one or more electrically conductive shields can be disposed at any location between transmit coil 1236 and display 1290 to attenuate electromagnetic noise that interferes with the operation of the touch sensitive display.

Transmit coil 1236 can be positioned within the housing of wireless charger such that it aligns with receive coil 1214 in the portable electronic device along a mutual axis when the charger is operatively attached to portable electronic device. If misaligned, the power transfer efficiency between the transmit coil and the receive coil may decrease as misalignment increases. The housing of the portable electronic device and the wireless charger can be designed to facilitate proper alignment between charging surface 1215 and charging face 1235 to ensure high charging efficiency. In some embodiments of the disclosure, transmit coil 1236 is moveable within the housing such that it can be accurately positioned to align with receive coil 1214 of different sized portable electronic devices 1210.

In some embodiments, one or more alignment assistance features can be incorporated into the devices to facilitate alignment of the transmit and receive coils along the mutual axis can be employed. As one example, an alignment magnet 1238 can be included in wireless charger 1230 that magnetically mates with an alignment magnet 1218 of portable electronic device 1210 to facilitate proper alignment of the portable electronic device and wireless charger. Additionally, the charging surface and charging face 1215, 1235 of portable electronic device 1210 and wireless charger 1230, respectively, may cooperate to further facilitate alignment. For example, in one embodiment charging surface 1215 of portable electronic device 1210 has a convex shape while charging face 1235 of wireless charger 1230 has a concave shape. In this manner, the complementary geometries may facilitate alignment of the device charger and wearable device in addition to the alignment magnets.

Although electronic device 110 (see FIG. 1) is described and illustrated as one particular electronic device, embodiments of the disclosure are suitable for use with a multiplicity of electronic devices. For example, any device that receives or transmits audio, video or data signals can be used with embodiments of the disclosure. In some instances, embodiments of the disclosure are particularly well suited for use with portable electronic media devices because of their potentially small and portable form factor. As used herein, an electronic media device includes any device with at least one electronic component that can be used to present human-perceivable media. Such devices can include, for example, portable music players (e.g., MP3 devices and Apple's iPod devices), portable video players (e.g., portable DVD players), cellular telephones (e.g., smart telephones such as Apple's iPhone devices), video cameras, digital still cameras, projection systems (e.g., holographic projection systems), gaming systems, PDAs, as well as tablet (e.g., Apple's iPad devices), laptop or other mobile computers. Some of these devices can be configured to provide audio, video or other data or sensory output.

For simplicity, various internal components, such as the control circuitry, graphics circuitry, bus, memory, storage device and other components of electronic device 100 (see FIG. 1) are not shown in the figures.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

What is claimed is:

1. An electronic device comprising:
an housing having a charging surface through which electromagnetic energy can be transferred;
an inductive charging receive coil disposed within the electronic device adjacent to the charging surface and configured to receive electromagnetic energy through the charging surface; and
an electrically conductive shield formed on a portion of the housing and electrically coupled to a ground potential of the electronic device.

2. The electronic device of claim 1 wherein the electrically conductive shield is disposed on an interior surface of the housing.

3. The electronic device of claim 1 wherein the electrically conductive shield has a sheet resistance between 2 ohm/square and 15 kiloohm/square.

4. The electronic device of claim 1 wherein the electrically conductive shield comprises a layer of electrically conductive carbon.

5. The electronic device of claim 4 wherein the layer of electrically conductive carbon has a sheet resistance between 2 ohm/square and 15 kiloohm/square and is between 5 and 50 microns thick.

6. The electronic device of claim 1 wherein the housing comprises glass.

7. The electronic device of claim 1 further comprising a touch sensitive user interface and wherein the electrically conductive shield is positioned and configured to shield the touch sensitive user interface from electromagnetic interference generated during inductive charging of the electronic device.

8. The electronic device of claim 1 further comprising one or more alignment features that enable the charging surface to be properly aligned with a wireless charger for a charging event.

9. The electronic device of claim 8 wherein the one or more alignment features include one or more magnets that assist in aligning the charging surface to the wireless charger.

10. An inductively charged electronic device comprising:
a housing having a charging surface through which electromagnetic energy can be transferred, the charging surface positioned on a first exterior surface of the housing;
a cover glass coupled to the housing and defining a second exterior surface of the housing;
a display positioned within the housing adjacent to and visible through the cover glass;
an inductive charging receive coil positioned within the housing and configured to receive electromagnetic charging energy through the charging surface; and
an electrically conductive shield formed on the housing, the electrically conductive shield coupled to a ground potential of the electronic device and configured to attenuate electromagnetic noise generated during inductive charging of the electronic device.

11. The inductively charged electronic device of claim 10 wherein the electrically conductive shield is disposed on an interior surface of the housing.

12. The inductively charged electronic device of claim 10 wherein the cover glass and the display are a portion of a touch sensitive user interface.

13. The inductively charged electronic device of claim 10 wherein the housing comprises the cover glass, a metal frame and a back crystal, wherein the electrically conductive shield is formed on a portion of the back crystal.

14. The electronic device of claim 10 wherein the electrically conductive shield comprises a layer of electrically conductive carbon.

15. The electronic device of claim 14 wherein the layer of electrically conductive carbon has a sheet resistance between 2 ohm/square and 15 kiloohm/square and is between 5 and 50 microns thick.

16. The electronic device of claim 10 wherein the electrically conductive shield is coupled to the ground potential of the electronic device with a conductor that is coupled to the electrically conductive shield with an electrically conductive epoxy.

17. The electronic device of claim 10 wherein at least a portion of the housing is made from a glass material.

18. An electronic system comprising:
an inductively charged electronic device including:
a touch sensitive user interface;
an housing through which electromagnetic energy can be transferred; and
an inductive charging receive coil disposed within the electronic device and configured to receive electromagnetic energy through the housing;
an inductive charging station having an inductive charging transmit coil configured to transmit electromagnetic energy to the inductive charging receive coil of the electronic device; and
an electrically conductive shield formed on the housing and configured to shield the touch sensitive user interface from electromagnetic interference generated during inductive charging of the electronic device.

19. The electronic system of claim 18 wherein the electrically conductive shield is disposed on an interior surface of the housing.

20. The electronic device of claim 18 wherein the electrically conductive shield comprises a layer of electrically conductive carbon.
